(19) United States
(12) Patent Application Publication
(10) Pub. No.: US 2009/0151209 A1
(43) Pub. Date: Jun. 18, 2009

(54) Display Device which Enables a Strip of Posters to Scroll Around a Support

(75) Inventors: Roger Blanc, Le Pin (FR); Viviane Blanc, Le Pin (FR); Caroline Blanc Andrei, Rives sur Fures (FR)

Correspondence Address: MILLER, MATTHIAS & HULL, ONE NORTH FRANKLIN STREET, SUITE 2350, CHICAGO, IL, 60606, US

(73) Assignee: JCDECAUX SOYER, NEUILLY SUR SEINE (FR)

(21) Appl. No.: 11/719,801

(22) PCT Filed: Nov. 16, 2005
(86) PCT No.: PCT/FR05/02839

§ 371 Date: Aug. 11, 2008

(30) Foreign Application Priority Data
Nov. 23, 2004 (FR) 0412422
Apr. 28, 2005 (FR) 0504296

(51) Int. Cl. G09F 11/29; G09F 13/04

(52) U.S. Cl. 40/471; 40/579

(57) ABSTRACT

The invention relates to a display device which enables a poster banner to scroll along the length of a support between two motorized winding shafts which are equipped with means for driving same sequentially in both directions and means for fixing the two ends of the poster banner. Accordingly, to the invention, the support is curved on the side comprising the poster banner, over at least part of the surface thereof. In addition, the support comprises an open-work wall which forms the front wall of a chamber that is intended to be pressurized with air when the winding shafts of the poster banner are actuated

The present invention relates to a display device which enables a strip of posters to scroll around a support.

Devices for scrolling a series of advertising or informational posters in a single location are known. Such devices are of particular value because although the display surfaces are limited, the advertising activity and informational activity are not affected.

Known display devices have an outer structure with a transparent face in front of a scrolling strip of posters, that is multiple posters joined end to end. This strip of posters is drawn past a transparent or translucent support, and lighting equipment may be installed behind this support.

Each end of the strip of posters is attached to a winding shaft. The two parallel winding shafts are located along two edges of the device, usually the two vertical edges. The winding shafts are powered and driven synchronously so that while one shaft is winding up part of the strip, the other shaft is simultaneously paying out an equal length of the strip. The winding shafts are turned on sequentially, so that the strip is moved by an amount equal to the length of one poster. When a poster is visible, the strip is stopped for a number of seconds to allow the public to see the contents of the poster. The strip is then moved on in the same direction to show the next poster, and so on until all the posters have been shown. At this point the direction of rotation of the winding shafts is reversed and the strip is fed back in the other direction.

Strip-scrolling display devices have a flat support. To prevent the strip of posters from rubbing against the support in a way which could interfere with the drive and even damage the strip, spacer rollers are provided at either end of the support, next to the two drive rollers.

Another type of display, often used in an urban environment, is the Morris column. A Morris column is a cylindrical structure whose exterior forms a display surface. The display surface offered by a Morris column is relatively limited. Because of where they are sited, typically on sidewalks and pedestrianized areas, there is no question of increasing the number of Morris columns, both for reasons of space and on esthetic grounds.

One way around this would therefore be to install scrolling display devices on these Morris columns. However, there is the problem of how to guide the posters around a curved surface, since if a poster is allowed to rub on such a surface, then, partly owing to the nature of the materials used, there will be problems with clinging due to static electricity. Malfunctioning is therefore highly likely and the strip may quickly become torn.

The technical problem addressed by the invention is therefore how to guide a strip of posters in a scrolling display device where the support against which the strip of posters moves is a curved support.

The invention solves this problem by means of a display device which enables a strip of posters to scroll around a support, between two motorized winding shafts, the shafts being fitted with means for driving them sequentially in both directions and being fitted with means of attachment for the two ends of the strip of posters, which device is characterized in that the support curves out toward the strip of posters for at least part of its surface, and in that the support includes a perforated wall which forms the front wall of a chamber, the air pressure inside which is designed to be increased when the winding shafts of the strip of posters are actuated.

Because of the shape of the support, the strip contacts at least part of its surface. The pressurized chamber behind the support, being perforated, allows the air to leak out in the direction of the poster. This air therefore lifts the poster off the support, creating a film which prevents the strip of posters from touching the support and becoming stuck in contact with it. This solution not only ensures that the strip of posters is not torn but also prevents excessive stresses on the drive shafts caused by the resistance they would encounter in trying to move the poster if it remained stuck to the support.

In one embodiment of this device, the perforated wall consists of a panel containing holes.

In another embodiment of this device, the perforated wall consists of at least one slat whose profile corresponds to the path of the strip of posters, each slat being oriented transversely relative to the winding shafts.

The perforated wall is advantageously translucent or transparent. This feature allows lighting to be provided behind the poster, making the display device usable at night.

Another, feature of the invention is that the chamber, the pressure inside which is designed to be increased, comprises a rear wall consisting of a plate, and peripheral walls consisting of frame sections.

In addition, the plate forming the rear wall is made of a translucent or transparent material.

If the support consists of a number of slats, each slat is mounted parallel to the rear wall, with interposed spacers made of a translucent or transparent material. This arrangement is designed to make the support invisible to the public, if lighting is provided from behind.

In another feature of the invention, the device comprises a fan whose delivery outlet is through an opening in the chamber in order to raise the pressure inside the latter when the fan is operating.

In addition, the fan operating control means are controlled by the operating control means of the motors driving the winding shafts of the strip of posters.

However, to enable the invention to be understood clearly, it will now be described with reference to the accompanying schematic drawings showing, for the purposes of non-limiting examples, several embodiments of this device.

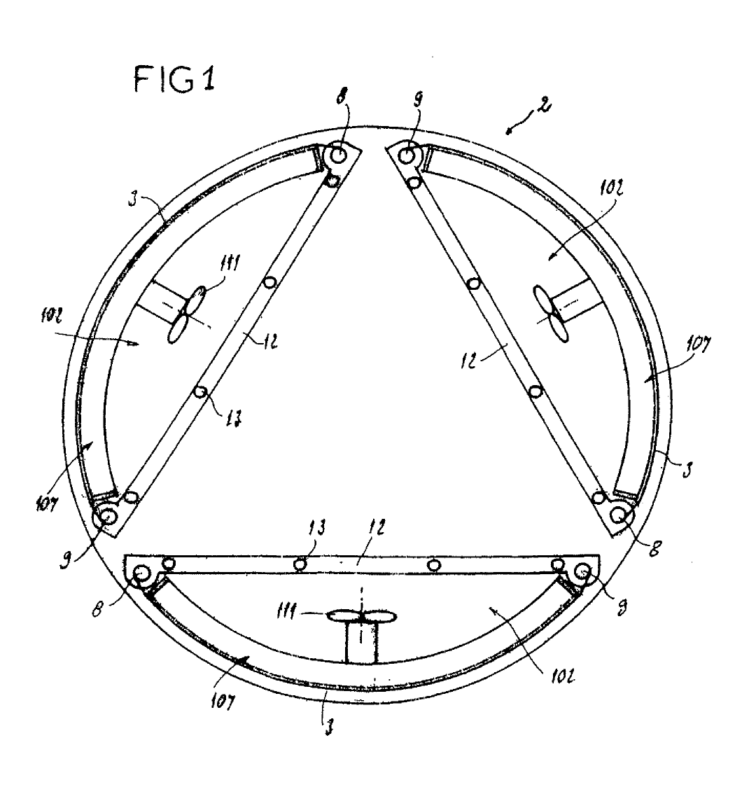

FIG. 1 is a cross section through a circular column fitted with three display devices.

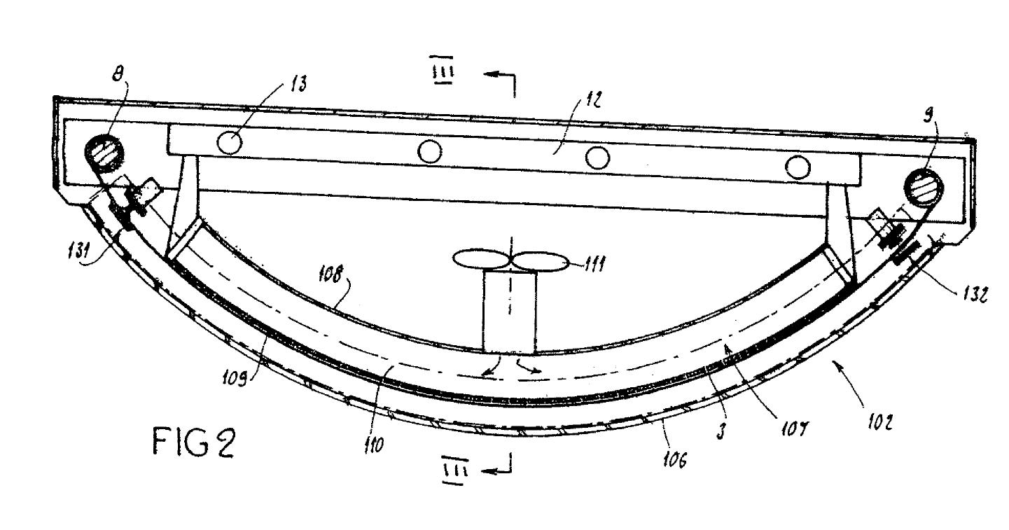

FIG. 2 is an enlarged transverse cross section through the display device shown in FIG. 1.

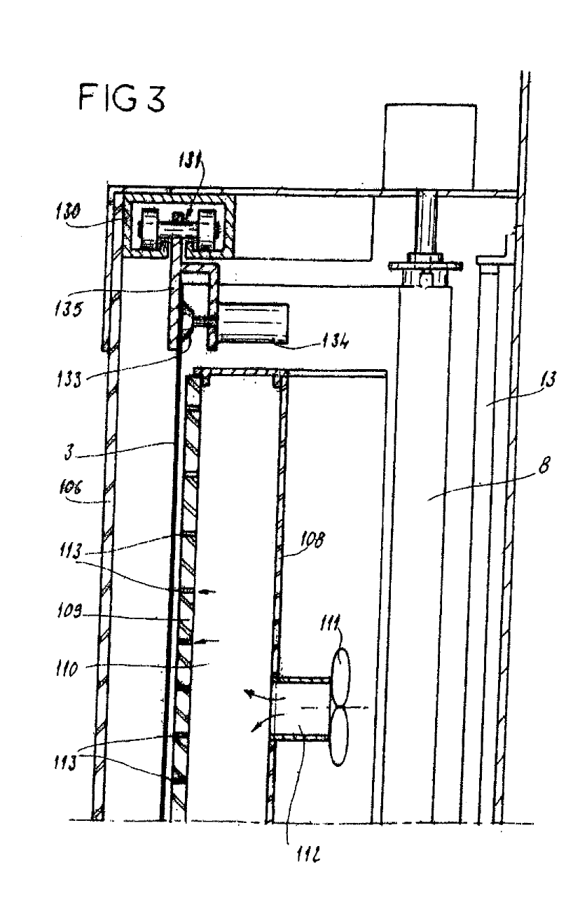

FIG. 3 is a cross section taken on the line marked III-III in FIG. 2 showing this display device.

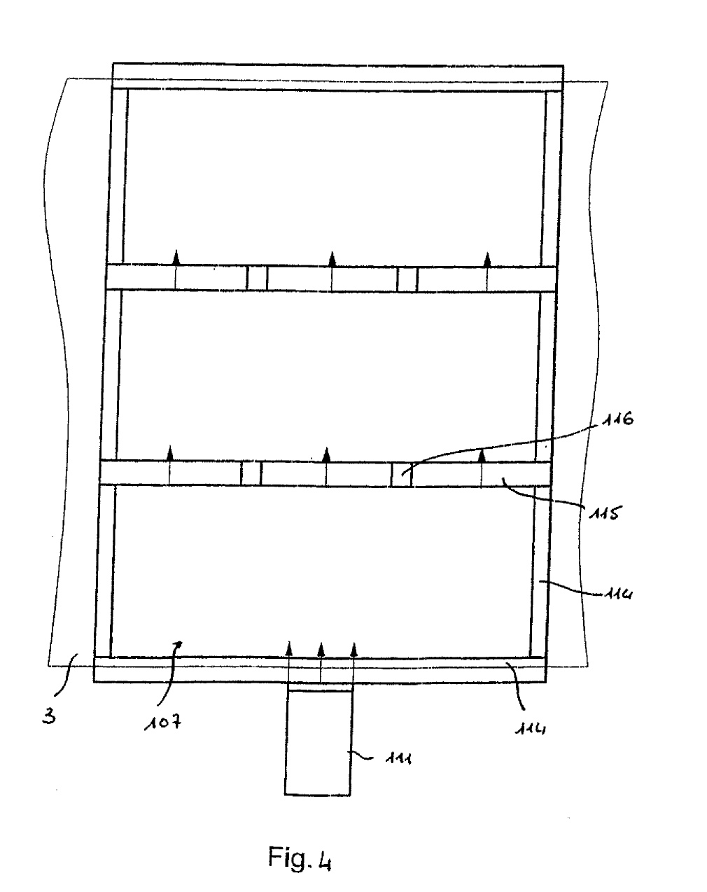

FIG. 4 is a front view of a second display device.

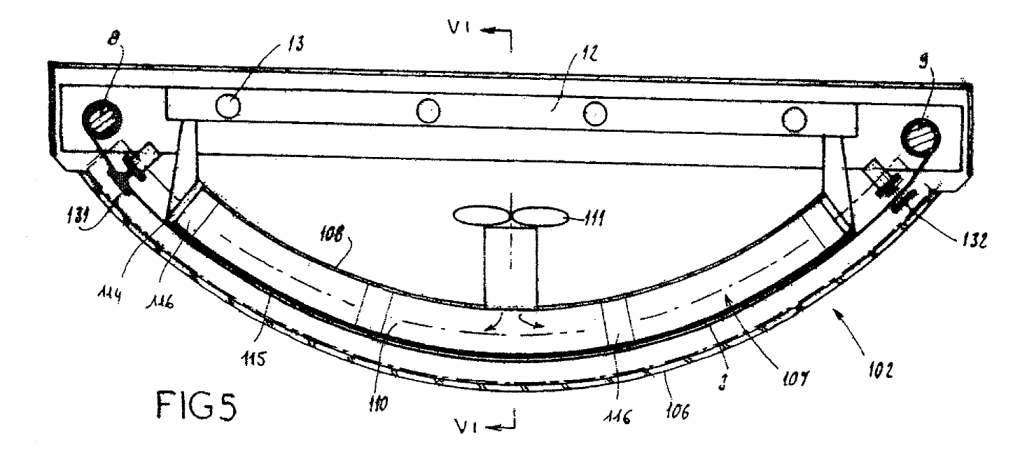

FIG. 5 is a transverse cross section through the display device shown in FIG. 4.

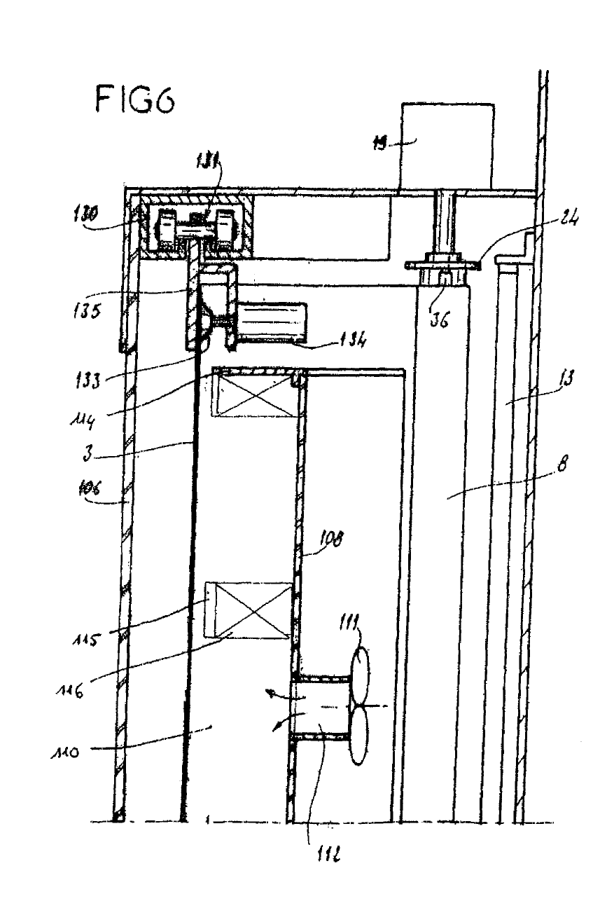

FIG. 6 is a cross section taken on the line marked VI-VI in FIG. 5, of this second display device.

FIG. 1 shows a circular structure 2, which may, for example, be a Morris column, having three display devices 102 for displaying three strip of posters 3 around its perimeter, Each strip of posters is mounted on a frame denoted by the general reference 4. On this frame are mounted two powered vertical shafts 8, 9 on which are wound the ends of a strip 3 of posters. The length of one poster is equal to the length of an arc of a circle, parallel to the outer surface of the column and at a short distance from it. The back of the frame 4, i.e. between the shafts 8 and 9, is equipped with a display device 12 comprising fluorescent tubes 13.

As shown more especially in FIG. 2, each display device 102 comprises a curved front 106 and a support 107, which comprises a rear wall 108 and front wall 109, both transparent or translucent and together defining an interior space or chamber 110. The chamber 110 is closed around its perimeter by a frame section 114. A fan 111 has a delivery orifice connected to the interior space 110 via an opening 112 formed approximately in the center of the rear plate 108. The front wall 109 is perforated by a multitude of holes 113 defining the perforation pattern.

In addition, and as shown in FIG. 3, the display device 102 is provided with a system for supporting the strip of posters 3: it comprises a guide rail 130 along which a first carriage 131 and a second carriage 132 can move. Each carriage 131, 132 has a sucker 133 operated by an electromagnet 134 to press the strip of posters against a supporting plate 135. It should be noted that the number of carriages 131, 132 is not limited to two, but depends on the number of posters present on the strip of posters 3, the number of carriages 131, 132 being equal to the number of initially concealed posters. For example, if the strip comprises three posters and has no leader, two carriages will be necessary.

When the drive shafts 8, 9 are turning, the fan 111 is turned on, causing the pressure in the chamber 110 to increase and air to escape through the holes 113 in the front wall 109. This escape of air through the perforation pattern creates a cushion of air against the surface of the front wall 109 between the support 107 and the strip of posters 3, thus preventing the strip from clinging to the support 107. The fan 111 and the perforated front wall 109 thus form guide means for the strip of posters 3. As the strip of posters 3 scrolls around, for example, from winding shaft 9 to winding shaft 8, the electromagnet 134 of the first carriage 131 is energized by an electronic control card (not shown) so that the sucker 133 grips the strip of posters 3 at approximately the join between the first and the second poster. The carriage 131 is then moved with the strip of posters and supports it until it arrives in the vicinity of the winding shaft 8 where the electromagnet 134 is de-energized so that the sucker 133 releases the strip of posters 3. The same applies to the second carriage 132 designed to support the strip of posters 3 at the join between the second and third posters. The carriages are activated in the same way when the winding shafts 8, 9 are driven in the reverse direction.

FIGS. 4-6 show a variant of this device in which identical components are denoted by the same references as before.

The essential difference here lies in the fact that the front wall around which the posters are guided is no longer a perforated panel but consists of two horizontal strips 115, made of a transparent or translucent material, plus the bottom and top parts of the frame section 114 closing the pressurizing chamber. The slats 115 are kept at a distance from the rear wall 108 by means of spacers 116, also made of a transparent or, translucent material. In this embodiment, it is the poster itself which closes the pressurizing chamber 110.

When the winding shafts 8 and 9 are stopped, and the fan 111 is also off and a poster is in the visible position, the curvature of the support means that the poster will press against the support and close the pressurizing chamber 110. When the shafts 8, 9 are turning and the fan 111 is creating an increased pressure in the chamber 110, the poster lifts off the support and is able to be scrolled, though it may make slight contact with the slats 115. However, as this contact is very limited there is no risk of the poster being damaged by clinging to the slats because of the raised pressure inside the chamber 110.

As will be clear from the above, the invention is a significant improvement on the prior art in that it provides a display device capable of scrolling a strip of posters around an at least partly curved support, without any risk of damage to the strip or of damage to the drive motors of the strip winding shafts due to excessive resistance of the strip caused by contact with its support. Clearly, the invention is not limited to the one embodiment of the device described above by way of example and instead encompasses all variants thereof. For example, the banner could be scrolled vertically rather than horizontally, or the number of guide slats could be different, without this constituting a departure from the scope of the invention.

1. A display device comprising:
two motorized winding shafts sequentially in both directions sequentially driven in two opposite directions and adapted to be attached respectively to two ends of a strip of posters,
an air chamber having a perforated front wall, at least part of said perforated front wall being curved with a convexity turned toward the strip of posters for curving said strip of banners,
and a pressurizing device for increasing air pressure inside the air chamber when the winding shafts of the strip of posters are actuated.

2. The device as claimed in claim 1, wherein the perforated front wall consists of a panel containing holes.

3. The device as claimed in claim 1, wherein the perforated wall comprises at least one slat which is adapted to support the strip of posters, said slat being oriented transversely relative to the winding shafts.

4. The device as claimed in claim 1, wherein the perforated front wall is either translucent or transparent.

5. The device as claimed in claim 1, wherein the chamber, further comprises a tear wall consisting of a plate, and peripheral walls consisting of frame sections.

6. The device as claimed in claim 5, wherein said perforated front wall and rear wall are either translucent or transparent material

7. The device as claimed in claim 3, wherein the chamber comprises a real wall and each slat is mounted parallel to the rear wall, with interposed spacers the rear wall, slats and spacers being either translucent or transparent.

8. The device as claimed in claim 1, wherein the pressurizing device comprises a fan adapted to blow air through an opening in the air chamber.

9. The device as claimed in claim 8, further comprising at least a control device which controls operation of the fan in synchronism with operation of the winding shafts.

10. The device as claimed in claim 4, further comprising a lighting device, wherein said perforated front wall has a rear surface opposite the strip of posters and said lighting device lights said rear surface of the perforated front wall.

11. The device as claimed in claim 10, further including a strip of posters having two ends respectively attached to said two winding shafts, said strip of banners bearing on said perforated front wall and being curved by said perforated front wall.

12. The device as claimed in claim 1, further including a strip of posters having two ends respectively attached to said two winding shafts, said strip of banners bearing on said perforated front wall.
